(19) United States
(12) Patent Application Publication
(10) Pub. No.: US 2010/0258726 A1
(43) Pub. Date: Oct. 14, 2010

(54) RADIATION POWER DETECTOR

(75) Inventors: Chunbo Zhang, Plymouth, MN (US); Yue Liu, Plymouth, MN (US); Steven J. Eichkhoff, Plymouth, MN (US)

Correspondence Address: HONEYWELL/SLW;Patent Services, 101 Columbia Road, P.O. Box 2245, Morristown, NJ, 07962-2245, US

(73) Assignee: Honeywell International Inc., Morristown, NJ (US)

(21) Appl. No.: 12/420,663

(22) Filed: Apr. 8, 2009

(51) Int. Cl. G01T 1/00; G01J 5/00; H01K 7/04

(52) U.S. Cl. 250/336.1; 374/121; 315/76

(57) ABSTRACT

A radiation power detector includes a thermal membrane that produces a voltage responsive to temperature differences. A radiation absorber is thermally coupled to the thermal membrane, and an indicator is coupled to the thermal membrane responsive to the temperature differences. The indicator is powered by voltage produced by the thermal membrane and signals the amount of radiation power to which the absorbing material is exposed.

### BACKGROUND

High power radiation detection has become increasingly important for both personnel protection and indication of high power radiation (e.g., high power microwave) attacks on fixed, mobile, or airborne systems. Current detectors are bulky and require a power supply to provide warnings of such attacks.

One approach uses a differential color change in patterned liquid crystal disks for passive microwave detection. However, liquid crystals are strongly affected by large ambient temperature variations and do not work in the dark. Another approach uses a microwave cavity/waveguide configuration to power a bulb emitting UV or visible light. This configuration has potential for passive high power microwave (HPM) detection, but generally requires a large volume/area and is not easy to miniaturize. In yet another case, RFID antennas convert power directly from the incoming RF/microwave signal for data processing and transmission. Such an antenna may require a large surface area, making it difficult to miniaturize.

### BRIEF DESCRIPTION OF THE DRAWINGS

FIG. 1 is a block schematic diagram of a radiation detector according to an example embodiment.

FIG. 2 is a block diagram top view and side view of a radiation detector and a side view of an alternative radiation detector according to an example embodiment.

FIG. 3 is a block perspective view of potential thermal paths of a radiation detector according to an example embodiment.

FIG. 4 is an equivalent thermal circuit diagram for the heat conduction through solids in a radiation detector according to an example embodiment.

FIG. 5 is a perspective three dimensional block diagram of a radiation detector system according to an example embodiment.

FIG. 6 is a series of cross section block diagrams representing a process for manufacturing a radiation detector according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, electrical, and optical changes may be made without departing from the scope of the present invention. The following description of example embodiments is, therefore, not to be taken in a limited sense, and the scope of the present invention is defined by the appended claims.

A radiation power detector includes a thermal membrane that produces a voltage responsive to temperature differences. A radiation absorber is thermally coupled to the thermal membrane, and an indicator, such as a light, sound, or other signal producing device, is coupled to the thermal membrane responsive to the temperature differences. The indicator is powered by voltage produced by the thermal membrane in one embodiment.

In one embodiment, a micromachined multi-layer membrane has thermoelectric (TE) layers that convert high power radiation energy to power electroluminescent (EL) devices. Various embodiments may provide one or more of a rapid and accurate response resulting from a MEMS membrane structure, large dynamic range (0.1-10 W/cm² and beyond), large design space on efficiency, fast response time, small device size. The power detector may be operable under wide range of field conditions, is passive, robust, and long lived, reusable, has a quick recovery, and a low-cost design, suitable for mass production.

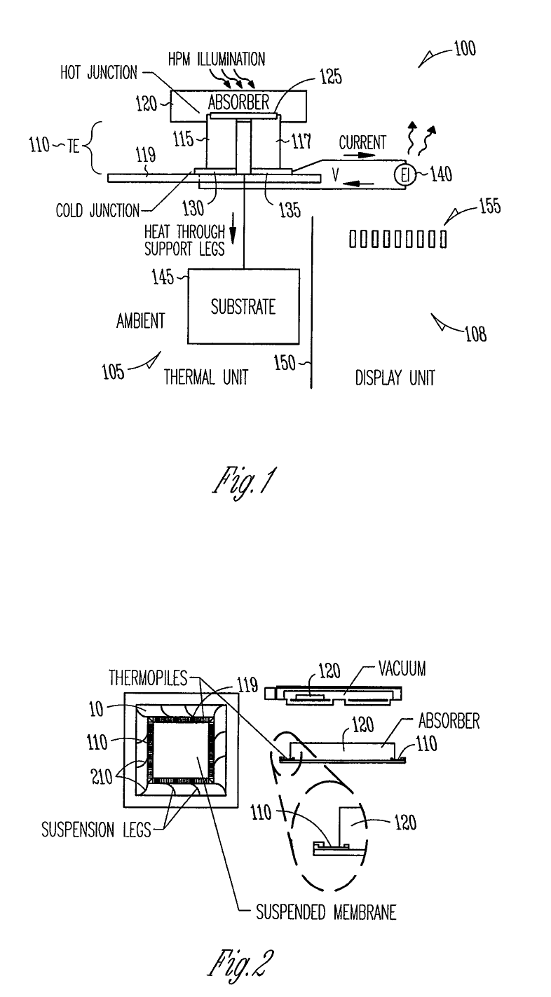

FIG. 1 is a block diagram of a power detector shown generally at 100. Detector 100 includes a thermal unit 105 and a display unit 108. In the thermal unit 105, a thermopile 110 consists of two series connected layers 115, 117 that generate an output voltage proportional to a local temperature difference or temperature gradient. The output of a single thermopile 110 is usually in the range of 1-100 millivolts. The thermopile 110 may be coupled to a membrane 119 in one embodiment, as shown in further detail below.

A radiation absorber layer 120 is coupled to a first end of the thermopile 110, via a hot junction 125. The membrane 119 with thermopile and radiation absorber layer 120 may be suspended inside a vacuum cavity via supports legs, such as straight, curved or zig-zagged legs. The vacuum helps to eliminate the thermal influence of air, and the suspension effectively minimizes ambient temperature influence. Multiple thermopiles 110 may be configured vertically or laterally to the membrane. Their hot junction 125 and cold junctions 130 and 135 are arranged inside the membrane 119 to minimize the voltage output resulting from ambient temperature variations.

The detector 100 may be packaged with a cap having a coated surface layer to reject unwanted illumination such as sunlight or laser beams. In some embodiments, when microwaves are to be detected, the coated surface layer may also reject one or more of UV and infrared radiation.

A display device 140, such as an EL device or devices may be arranged in a bar meter type array as represented at 150. Under high power microwave illumination, some EL devices light up when the corresponding electrical outputs generated by the thermopiles exceed the EL thresholds.

In a further embodiment, fuses 155 made of thin film resistors may be used to record a device histogram with permanent burn marks. Each EL or fuse device may be connected to a different combination of thermopiles, which are connected in series. The detector 100 may be fabricated using mature MEMS processes. The micro dimension control provided by MEMS technologies allow accuracy, fast response, and small form factor for detector 100. In place of a vacuum package, an aerogel may be used to simplify fabrication without the need of a vacuum package. Aerogel films of close to 99% porosity may be prepared using a sol-gel process.

The heat transfer and conversion in the detector 100 are engineered in micro scale in one embodiment for precision, compact size, and robustness. In one embodiment, the radiation absorber layer 120 may be a film that is filled with radiation absorbing magnetic/dielectric particles. Layer 120 rapidly and uniformly converts high power radiation, such as microwave, RF or IR into heat. The layer 120 may be optimized to detect one or more of such forms of radiation if desired by selection of appropriate materials. A vacuum package (or aerogel) removes (or minimizes) air heat dissipation and variation.

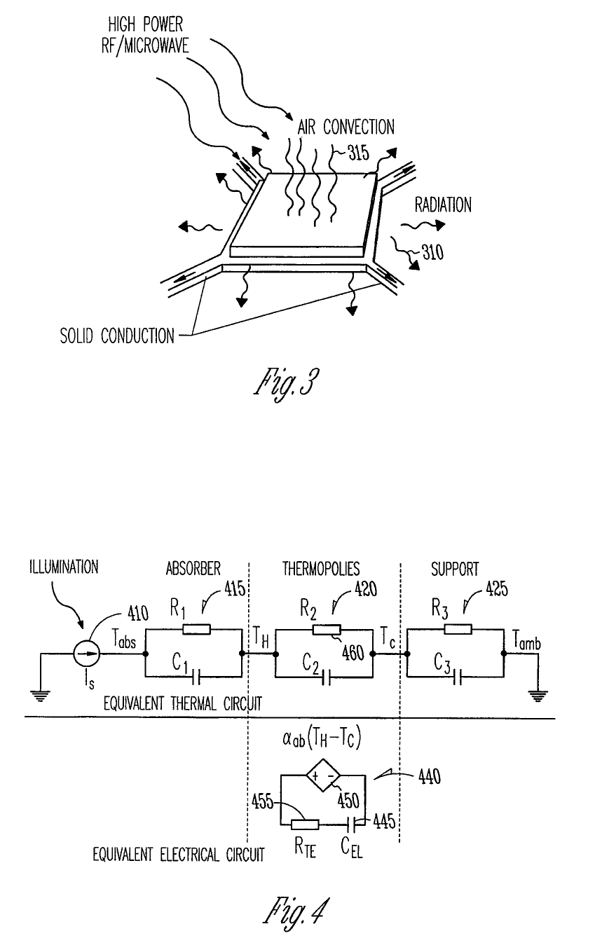

Thermopiles of one millimeter or less (down to one micron length) may provide response time of one second or less. Microfabrication technologies enable the placement of thousands of thermopiles 110 with precise geometric definition in a small area as illustrated in block form in top and side and exploded views in FIG. 2. The reference numbers used in FIG. 2 are consistent with those used in FIG. 1. The thermopiles 110 may be connected in series to produce the desirable voltage output and accurate response. The suspension legs 210 may be designed with large thermal resistance and thermal time constant to ensure that the thermopile 110 temperature difference resulting from large ambient/substrate temperature variation is small. When higher precision is needed, two identical sets of thermopiles can be fabricated in two membranes 119 as illustrated in FIG. 2. The first has the radiation absorber 120 on top of its hot junctions 125, while the other has no absorber layer as shown at 215 in the top-right side view in FIG. 2.

In a further embodiment, as illustrated in FIG. 2, the first membrane 119 has a radiation absorber 120, and the second membrane 119 has a layer 220, which has no radiation absorbing particles.

In one embodiment, the two thermopiles may be connected in a differential configuration to zero the output resulting from ambient variations. The TE material and its stoichiometry may be chosen and characterized for good temperature stability over a large temperature range (e.g., −40 to +80° C.). If desired, TE materials with reverse temperature dependencies may be combined to provide a very small temperature dependence in the TE outputs.

In one embodiment, detector 100 uses a lateral TE configuration where the membrane 119 is suspended by many curved or zig-zagged legs 210. The curve or zig-zag serves two purposes: 1) to make the leg long enough for the desired thermal resistance and thermal time constant; and 2) to release some thermal and mechanical stresses by allowing the membrane to rotate and alleviate bending/buckling resulting from stress concentration. In further embodiments, the legs may be curved, zig-zagged or otherwise patterned to optimize thermal resistance.

The center square is the absorber 120 of 10-100 μm thickness, which occupies most of the membrane 119 area for maximum heat absorption. Surrounding the edges are the thermopiles 110 of 1-2 mm or less, targeting a less than 1 sec response time. Their hot junctions 125 are buried inside the thick absorber 120 and their cold junctions 130, 135 are near the membrane edge. The support layer underneath the absorber 120 and thermopiles 110 and the leg supports 210 are made of low thermal conductivity material such as silicon oxide, nitride, or their composites. In one embodiment, membrane 119 may use a long rectangular instead of square shape, which could provide more thermopiles and higher voltages.

In one embodiment, detector 100 is governed by a heat equation with a power consumption term from thermopiles 110 and a Neumann boundary condition from radiation absorption. The possible heat dissipation paths from the membrane 119 include solid conduction through the supports 210, convection and conduction to the air. The heat dissipation paths are illustrated in a thermal block diagram of FIG. 3. Radiation loss 310 is only a few percent of the absorbed energy and is therefore negligible. The natural convection 315 and conduction of air is about 10 mW/cm² in magnitude at a 10K temperature difference to ambient. The air convective loss varies greatly with environmental and operational conditions such as temperature, speed, and surface orientation. By suspending the membrane 119 inside a vacuum package, air heat dissipation is eliminated. MEMS vacuum packaging technology can seal a cavity and maintain a good vacuum around 10 mTorr-1 Torr for many years.

In a further embodiment, the membrane 119 is embedded inside an aerogel to eliminate the unpredictable air convective loss and leave only a small and steady aerogel conduction loss. Aerogel is a good thermal insulation material with up to 99% volume occupied by air and has a low thermal conductivity close to air. Convective air flow cannot occur inside an aerogel because of its small pore size.

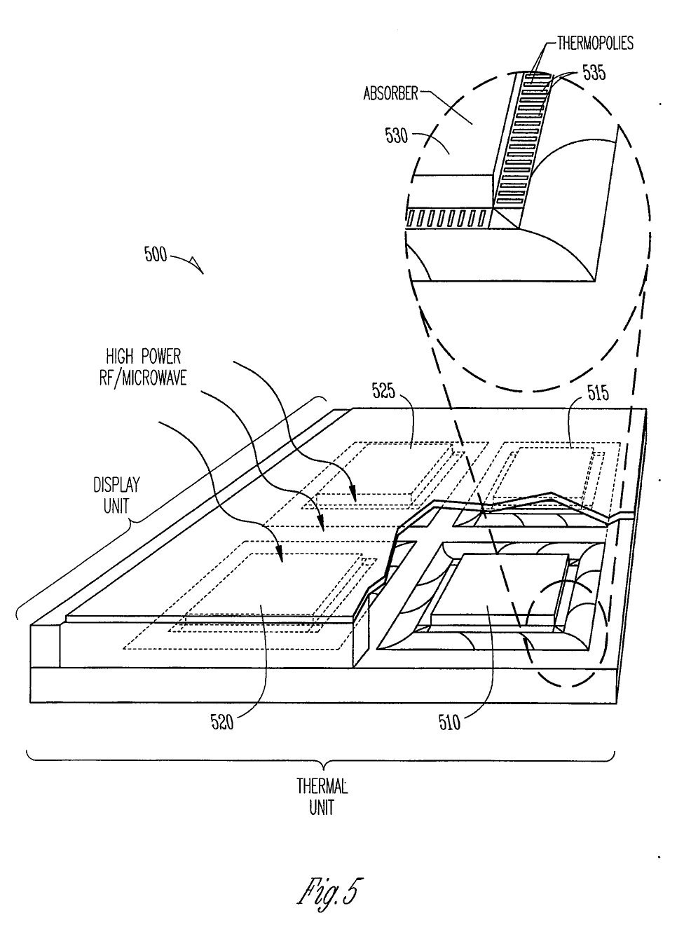

The remaining thermal design is focused on the solid heat conduction from absorber to device substrate through the thermopiles 110 and the suspension legs 210. The detector 100 may be pictured using a thermal equivalent circuit model as shown in FIG. 4, where the radiation absorption is equivalent to a constant current source 410, and the thermal membrane structure is simplified and approximated to three sub circuits 415, 420 and 425 respectively, connected in series for absorber (R₁ and C₁), thermopiles (R₂ and C₂), and membrane support (R₃ and C₃). Temperature is analogous to voltage and heat flow is analogous to current in the thermal circuit. Furthermore, the thermal circuit is coupled to an equivalent electrical circuit 440 through a TE effect, where the EL device is treated as a capacitor (C_{EL}) 445 and the thermopiles are represented by a temperature control voltage source (V_{TE}) 450 in series with a resistor (R_{TE}) 455. The temperature difference between thermopile junctions is determined by the transient current flowing through the thermal resistor R₂ at 460. This transient current increases over time since the current flowing to the capacitors C₁, C₂, and C_{EL} decreases gradually as the capacitors are being charged. The EL device lights up when the capacitor C_{EL} is charged to the EL threshold voltage.

In one embodiment, the detector 100 is a radiation power detector that indicates instantaneous power of radiation, such as high power microwave radiation. As a power meter, the detector 100 response relates to the instantaneous power monotonically. If the current flowing through R₂ is equal or very close to the total current Iₛ at the end of illumination, the monotonic relation is realized. This current condition implies that the capacitors C₁, C₂, and C_{EL} are almost fully charged. In other words, the charging time constants for the three capacitors are significantly smaller than the illumination duration t₀ (generally at least 2-3 times smaller is sufficient)—the design requirement for this power meter to achieve high accuracy. On the other hand, if the capacitors are not close to fully charged at the end of illumination, it is difficult to extract the instantaneous power from the output since the maximum output voltage is also a function of illumination duration. Instead, the detector 100 may in this case serve as an energy meter, since it is possible to extract the power-duration product (i.e., total absorbed energy) with careful transient process design.

The membrane suspension effectively isolates the thermopiles from ambient temperature influence. When a sudden large ambient/substrate temperature change (ΔT_{amb}) occurs, there is little induced temperature difference in the thermopiles if the thermal resistance (R₃) and thermal time constant (R₃C₃) of the leg supports are much larger than those of the thermopiles. Careful thermal design of the leg support geometry and material can make the R₃ and R₃C₃ 10-1000× larger. During a sudden ΔT_{amb}, the much larger R₃C₃ ensures enough time to reach steady state or quasi-steady state inside the thermopiles and therefore prevents large transient temperature difference between junctions. The much larger R₃ and R₃C₃ together ensure a small induced temperature difference inside thermopiles (ΔT=T_{H}−T_{C}), not larger than ΔT_{amb} times the ratio of R₂/(R₃+R₂). In one embodiment, the detector 100 ensures that this induced temperature difference does not affect the device response and accuracy.

In one embodiment, the charging time constants of the capacitors C₁, C₂, and C_{EL} are designed to be ˜0.1-10 ms magnitude, the illumination duration is 0.5 s, and the support RC is ˜0.7 s. With this design, the thermopile temperature difference (T_{H}−T_{C}) approaches a constant during the illumination duration and returns rapidly to zero after the illumination is off. The influence of ambient temperature variation can be made insignificant with careful leg support design (an induced TE output less than 2% of the output under high power microwave achievable).

A large design flexibility (10 ns-10 s magnitude) is available for tailoring device response time by engineering the thermal time constants in device critical heat paths. TABLE I below lists transient processes and (estimated) time constants in the sequence of energy conversion or transfer inside the device. In one embodiment, the design focus is on the processes in bold. Of those, the heat diffusion from hot to cold junctions is significant for device response time. The time constant of this heat diffusion (RC=L²/D) is governed by the thermopile length (L) and TE material thermal diffusivity (D). For a response time below 1 sec, the thermopile time constant may be less than 100 ms for high accuracy, which leads to a length of a Bi₂Te₃ thermopile to be less than 1.6 mm. Such a thermopile may be microfabricated in the lateral TE configuration. On the other hand, if the thermopiles have a length less than 30 μm (for a device response time less than 100 μs), the device may be microfabricated in the vertical TE configuration to achieve a large number of piles.

TABLE I

| Process | Time constant |
|---|---|
| Microwave absorption | 1 ps-1 ns |
| energy relaxation | |
| Heat diffusion from | 2-40 ns for hot junction thickness 0.2-1 μm |
| absorber to hot junction | |
| Heat diffusion from hot | 10 ns to 4 sec for thermopile length 0.5 μm |
| to cold junction | to 1 cm |
| Voltage establishment in | <10 ns (~1 ns for electron diffusion through |
| thermopile | 1 μm. Electrical field propagates in light |
| | speed.) |
| EL capacitance charging | 20 ns to 2 ms for EL device of 100 μm |
| EL persistence in | 1 ms−1 sec or beyond |
| phosphor layer | |
| Heat diffusion from | 10 ms-10 sec |
| membrane to substrate | |

Overall high power microwave-to-light efficiency of ˜10⁻⁵ can be expected in one embodiment of detector 100. Overall light efficiency may be governed by the efficiencies of the radiation absorption, thermoelectric conversion, and EL device charging and electric-to-light conversion. Commercially available absorber materials can be used to get >10% absorption with 15 μm thickness. TE material such as bismuth telluride and superlattices can provide conversion efficiency of 0.5-1% at ΔT=10K. EL devices (such as light emitting diodes (LEDs)) can achieve a light efficiency of 1-10%.

An example minimum requirement for the overall light efficiency is estimated to be up to four orders of magnitude lower than the expected overall efficiency above. Under indoor office lighting (500 Lux) and diffused reflection surfaces (50% reflectance), an indicator at 555 nm with 30 nm line width would need to emit a minimum 130 nW/mm² to be deemed bright enough to the human eye. The brightness requirement of the EL device can be further reduced by applying a black (absorptive or non-reflective) surface around the indicator to significantly reduce the “background” luminance (by a factor of 10× or more) and enhance its display contrast. Therefore, a small indicator (sub-mm size) requires only a few nW of light output power to be visible for the human eye. This 9-11 orders of magnitude lower power requirement than the available high power microwave (HPM) power (total of 0.6 to 60 W magnitude of HPM in the 1×1 inch² area) provides a large design margin for the minimum requirement of overall light efficiency (10⁻⁹).

The large efficiency margin may be used to reduce device size and reduce cost (<0.25 inch), while enhancing the structural robustness. With this margin, example devices may have a size of about 1 mm magnitude. High device yield and low cost can be expected with the small die size. The efficiency margin may also be used against geometry and material to make a more robust but less efficient structure, such as wider and thicker legs and material with good temperature dependence but lower efficiency.

In one embodiment, a commercially available absorption material may be used on the membrane. The absorption layer may be made of dielectric or magnetic material with a high loss factor tailored for the frequency range of interest. As an example, the thin Wave-X™ sheet (thickness 254 μm) from ARC Technologies uses inductive coupling to magnetic fillers to achieve the <−7.5 dB transmission attenuation in the 0.5-3 GHz band. A ˜10% microwave absorption can be achieved with a thickness of 15 μm (two passes with a reflective coating underneath).

An example EL device may be viewed as a “lossy capacitor” in that it becomes electrically charged and then loses energy as light. Inorganic and organic LEDs can be driven by DC voltages of 2 to 3.5 V, depending on the device type and emission wavelengths (colors). Thin film EL devices may be driven with 3-10 V. In one embodiment, a 0.5 sec indication lag may exist after the HPM threat is removed. A suitable EL phosphor for a 0.5 sec light persistence after the HPM is removed is desired. A long persistence example is MgF₂:Mn with over 1 sec persistence for radar screens.

Thermopile materials such as BiTe, SbTe, and superlattices can provide high Seebeck coefficients (>200 μV/K) and sufficient conversion efficiency. The thermopiles should provide high enough voltage for the EL device (3-5 V), which may be obtained by using a significant numbers of thermopiles connected in series, especially in the vertical TE configuration with less than 30 μm thermopile lengths for ultra fast response. For example, to generate 5 V under 0.1 W/cm² illumination and 10% absorption in a lateral TE configuration, rough estimates indicate that on the order of 100 or 1000 thermopiles may be coupled in series. This is not difficult to achieve as thermopiles with sizes as small as a few microns may be microfabricated.

The temperature stability of a thermopile output is related to temperature dependences of material properties, mainly the Seebeck coefficient and the thermal conductivity of the TE material used. A number of thermoelectric materials have demonstrated a small temperature dependence around room temperatures over the range of −40-80° C. For example, Osamu Yamashita (Applied Energy 85, 2008, 1002-1014) showed that Bi₂Te₃ has less than 10% variation of its Seebeck coefficient and thermal conductivity over a 50 K temperature change. Literature also shows that it is possible to tune TE material's stoichiometry for a flat temperature dependence (e.g., Journal of Solid State Chemistry, 181, 2008, 3278-3282).

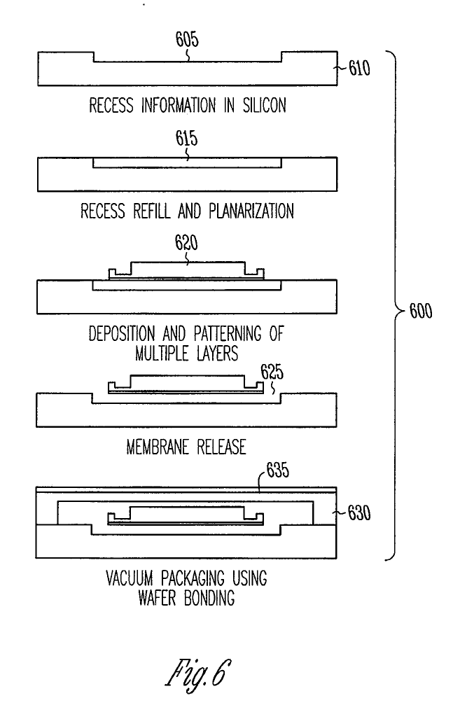

FIG. 5 is a block perspective diagram of a radiation detection system 500 that includes multiple detectors 510, 515, 520, 525 each having a membrane arranged in an array. The use of several small suspended membranes instead of a single large one inside one device is to enhance mechanical strength and shock resistance of a detection system. Many more detectors may be utilized in such a detection system 500 in further embodiments. In general, the smaller the membrane, the more robust the device. Devices of approximately 50 μm are quite robust. Detector 510 is shown in further detail in the inset. The absorber layer 530 may distribute over all the detectors in one embodiment. The inset also shows further detail of laterally disposed thermopiles at 535 coupled in series to provide a desired voltage in response to a temperature difference. A display unit 540 consisting of EL devices and/or fuses is disposed along a lateral edge of detection system 500 in one embodiment. As previously discussed, the display unit 540 may optionally be an audio indicator, or even a transmitter for transmitting signals representative of the detected radiation in further embodiments, facilitating communication of detected radiation to a user or beyond the user to other users or a central controller if desired.

Ambient temperatures where detectors may be used may vary drastically in a few seconds in scenarios such as a person standing in an air-conditioned doorway, walking from a heated shelter into an arctic environment, or in an aircraft where a variety of temperature layers are seen during steep climbs/dives. The ambient effects could be threefold: 1) large ambient temperature variations may introduce a large thermopile signal, resulting in a false alarm; 2) the induced thermopile signal, even small, may make the device signal quantitatively inaccurate; or 3) the material properties may vary with ambient temperature, causing inaccuracies. The first two effects can be made insignificant by membrane suspension, long legs, and, if needed, by using the differential configuration of two membranes (one with absorber, the other without) to zero the effect. The third effect is related to temperature dependences of material properties. Bi₂Te₃ has demonstrated a less than 10% variation of its Seebeck coefficient and thermal conductivity over a 50 K temperature change. Material selection and design may be used to tune the temperature dependences of various TE materials in relation to material stoichiometry. Thermopiles may also be fabricated using a combination of TE materials with complimentary temperature dependences to realize a very small overall temperature dependence (e.g., in the range of −40 to +80° C.).

In one embodiment, the detector 100 is robust against various field conditions, including unwanted illumination (e.g., laser beams), night-time operation (unlike liquid crystal), human fatigue (device histogram recorded by burned fuses), and the following: (1) temperature: the vacuum package and membrane suspension effectively minimize ambient temperature influence, and the TE material selection or combination will ensure a high temperature stability of the thermopile output. (2) metal line coupling: Microwave energy coupling into metal lines and thermopiles is not expected to be significant due to the small dimensions. The TE junctions and the metal lines can be effectively shielded by metal layers on top as needed. (3) 6-foot drop: Micro electromechanical systems (MEMS) flow sensors, microbolometers, pressure sensors, and accelerometers have demonstrated significant shock resistance.

The device fabrication in one embodiment uses mature MEMS processes as illustrated in FIG. 6 generally at 600. The fabrication starts from the creation of a shallow recess 605 in a silicon wafer 610 by dry or wet etches. The recess 605 is refilled with a sacrificial material 615, and the surface is polished to the silicon wafer 610 layer. The layers for membrane support, TE materials, metal contacts and lines, cold junction coverage, and absorber are then deposited and patterned in the sequence as represented at 620. Among them, TE materials are deposited by ion-beam co-sputtering (for lateral TE configuration) or electrochemical deposition (for vertical TE configuration). Cold junction coverage is a thick-layer, high-thermal-conductivity material to keep the cold junction/membrane edge in uniform temperature, and the absorber layer is deposited by spin-coating and patterning a mixture of absorber particles and photoresist. Alternatively, the absorber process can also be the adhesion of an absorber thick film.

Next, the sacrificial material 615 is removed by wet etch and the suspended membrane is released as indicated at 625. The silicon wafer may then bonded to a glass wafer 630 in a solder bonding process (for example, using indium or indium alloy for <200° C.) in vacuum. In the end, a top layer 635 or multiple layers are pasted on the device top to reject unwanted illuminations. The finished silicon wafer is then diced and individual die are packaged with commercial off-the-shelf (COTS) display devices through wirebond or solder-bond. The overall process involves 7-9 masks for pattern generation using photolithography.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A radiation power detector comprising:
a thermal membrane that produces a voltage responsive to temperature differences;
a radiation absorber thermally coupled to the thermal membrane; and
an indicator coupled to the thermal membrane, responsive to the temperature differences, and powered by the thermal membrane.

2. The radiation power detector of claim 1 wherein the thermal membrane comprises thermopiles.

3. The radiation power detector of claim 2 wherein the thermal membrane comprises multiple thermopiles coupled in series to produce a voltage compatible with the indicator.

4. The radiation power detector of claim 2 wherein the thermopile is vertically disposed on the membrane.

5. The radiation power detector of claim 2 wherein the thermopile is laterally disposed on the membrane.

6. The radiation power detector of claim 1 wherein the indicator comprises an electroluminescent device.

7. The radiation detector of claim 6 wherein the electroluminescent device comprises multiple electroluminescent devices coupled to the thermal membrane to form a bar meter wherein a larger temperature difference results in more electroluminescent devices in the bar meter emitting light than a smaller temperature difference.

8. The radiation power detector of claim 1 wherein the radiation absorber and thermal membrane are suspended in a vacuum or thermally insulating material.

9. The radiation power detector of claim 1 wherein the radiation absorber absorbs at least one of microwave and RF radiation.

10. The radiation power detector of claim 1 and further comprising a second thermal membrane without a radiation detector coupled to the thermal membrane with radiation absorber in a differential configuration to reduce ambient temperature influence.

11. A radiation detector system comprising:
an array of thermal membranes that produce voltages responsive to temperature differences;
a radiation absorber or absorbers thermally coupled to the thermal membranes; and
an indicator or indicators coupled to the thermal membranes, responsive to the temperature differences, and powered by the thermal membranes.

12. The radiation detector system of claim 11 wherein the thermal membranes comprise a plurality of thermopiles selectively coupled in series to generate one or more output voltages proportional to a local temperature difference or temperature gradient.

13. The radiation detector system of claim 12 wherein the thermopiles are laterally disposed on the membrane.

14. The radiation detector system of claim 12 wherein the indicator comprises a plurality of electroluminescent devices coupled to form a bar meter quantitatively indicative of the power of radiation detected.

15. The radiation detector system of claim 12 wherein the indicator comprises multiple fuses coupled to different numbers of series coupled thermopiles to provide a histogram representative of the power of radiation exposure of the radiation detection system.

16. The radiation detector system of claim 11 wherein the radiation absorber comprises a layer made of at least one of a dielectric or magnetic material with a high loss factor.

17. The radiation detector system of claim 11 wherein the radiation absorber absorbs at least one of microwave and RF radiation.

18. The radiation detector system of claim 11 and further comprising:
a substrate adapted to support the membranes via legs; and
a package to minimize heat convection.

19. The radiation detector system of claim 18 and further comprising a selective layer positioned between a radiation source and the radiation absorber to reflect or absorb undesired radiation.

20. A method comprising:
exposing a radiation absorbing material to radiation;
converting heat generated in the radiation material responsive to such radiation to a voltage; and
powering a visual indicator representative of the amount of radiation power to which the absorbing material is exposed.
